(19) United States
(12) Patent Application Publication
(10) Pub. No.: US 2012/0185561 A1
(43) Pub. Date: Jul. 19, 2012

(54) HTTP Notification Gateway

(75) Inventors: Mikael KLEIN, Huddinge (SE); Christer BOBERG, Tungelstra (SE); Anders LINDGREN, Alvsjo (SE)

(73) Assignee: TELEFONAKTIEBOLAGET L M ERICSSON (PUBL), Stockholm (SE)

(21) Appl. No.: 13/351,566

(22) Filed: Jan. 17, 2012

Related U.S. Application Data
(60) Provisional application No. 61/433,321, filed on Jan. 17, 2011.

(51) Int. Cl. G06F 15/16

(52) U.S. Cl. 709/217

(57) ABSTRACT

Presented are methods and apparatus for obtaining event notifications by a client. A notification gateway server collects event notifications from a plurality of application servers and provides them to the client through outstanding event requests. The client initializes the notification gateway server for establishing a notification channel between the client and the notification gateway server. The client then uses at least one notification request, such as an HTTP long polling request, to collect the event notifications from the notification gateway server. The client sends another notification request to the notification server each time event notifications are received.

### RELATED APPLICATION

The present application is related to, and claims priority from, U.S. Provisional Patent Application No. 61/433,321, filed Jan. 17, 2011, entitled “HTTP Notification Gateway”, to Mikael Klein, Christer Boberg and Anders Lindgren, the disclosure of which is incorporated herein by reference.

### TECHNICAL FIELD

The present invention relates generally to telecommunications systems, and in particular, to methods, systems, devices and software for notifications to be sent to devices about their various subscriptions.

### BACKGROUND

Radiocommunication networks were originally developed primarily to provide voice services over circuit-switched networks. The introduction of packet-switched bearers in, for example, the so-called 2.5 G and 3 G networks enabled network operators to provide data services as well as voice services. Eventually, network architectures will likely evolve toward all Internet Protocol (IP) networks which provide both voice and data services. However, network operators have a substantial investment in existing infrastructures and would, therefore, typically prefer to migrate gradually to all IP network architectures in order to allow them to extract sufficient value from their investment in existing infrastructures. Moreover in order to provide the capabilities needed to support next generation radiocommunication applications, while at the same time using legacy infrastructure, network operators could deploy hybrid networks wherein a next generation radiocommunication system is overlaid onto an existing circuit-switched or packet-switched network as a first step in the transition to an all IP-based network. Alternatively, a radiocommunication system can evolve from one generation to the next while still providing backward compatibility for legacy equipment.

As part of the evolution of such systems, services and applications also continue to grow. Some examples include location-based services, messaging services, presence-based services, etc. The Open Mobile Alliance (OMA) is one standardization body which works on establishing protocols for such services.

As part of the OMA ParlayREST standardization initiative, a number of new application programming interfaces (APIs) are being standardized such as Presence, ALM (Address List Management), 3^{rd} Party Call, Terminal Location, Device Capabilities, Video call, Messaging, Session based chat etc. The purpose of these APIs is to provide an HTTP binding towards a respective enabler (in addition to the existing SIP and XCAP interfaces). Each API provides RESTFul HTTP operations in order to manage data, such as “set presence”, “retrieve watcher”, “start chat” etc. In addition, a subscribe/notify mechanism is provided allowing a client to start a subscription and, by providing a call back URL in the request, the server will be able to send a notification whenever there is a new event.

However, it is not clear how so-called “thin clients”, e.g., clients which typically run within web browsers, can be addressed using such a mechanism since there is no web server in the web browser and, therefore, the subscribe/notify mechanism will not work, since an HTTP request from the server to the client is not possible.

### ABBREVIATIONS/ACRONYMS

2.5 G Second and a half Generation Mobile Telecommunications
3 G Third Generation Mobile Telecommunications
3GPP Third Generation Partnership Program
ALM Address List Management
API Application Program Interface
GSMA Global System for Mobile Communications Association
HTTP HyperText Transfer Protocol
IETF Internet Engineering Task Force
IP Internet Protocol
MSRP Message Session Relay Protocol
NGW Notification Gateway
OMA Open Mobile Alliance
ParlayREST Representational State Transfer Bindings for Parlay X Web Services
RC Radio and Core
RCS Rich Communication Suite (GSMA)
SIP Session Initiation Protocol
UA User Application
URL Uniform Resource Locator
XCAP Extensible Markup Language Configuration Access Protocol

### SUMMARY

According to one exemplary embodiment, a method, stored in a memory and executing on a processor, for obtaining event notifications by a client includes transmitting, by the client toward a notification gateway, a request to create a notification channel. The client receives, from the notification gateway, a reply to the request comprising information associated with said notification channel. The client transmits, toward the notification gateway, a long polling notification request to maintain the notification channel for the event notification. These steps can be performed by the client transmitting HTTP messages.

According to another exemplary embodiment, a method, stored in a memory and executing on a processor, for providing event notifications to a client includes receiving, by a notification gateway from the client, a notification channel establishment request. The notification gateway establishes a notification channel associated with the client and transmits, from the notification gateway toward the client, information associated with the notification channel. The notification gateway receives, from the client, a long polling notification request. These steps can be performed by a notification gateway transmitting and receiving HTTP messages.

According to another exemplary embodiment, a notification gateway server for providing event notifications to one or more clients includes a processor for executing computer instructions and a memory for storing the computer instructions. The computer instructions further comprise: a notification channel initialization component for establishing a notification channel with the client, an engine component for processing information associated with the event notifications and a communication component for receiving at least one long polling request to maintain said notification channel. The communication component sends replies associated with providing the event notifications to the client.

According to another exemplary embodiment, a client device for obtaining event notifications includes a processor for executing computer instructions and a memory for storing the computer instructions. The computer instructions further comprise: a notification component for generating one or more notification channel creation requests and one or more long polling notification requests and a communication component for sending and receiving information associated with obtaining the event notifications. The communication component maintains an outstanding long polling notification request.

According to another exemplary embodiment, a notification gateway server for providing event notifications includes a processor for executing computer instructions and a memory for storing the computer instructions wherein the computer instructions further comprise: an initialization component for establishing a notification channel with a client, a multiplexer component for consolidating event notifications from a plurality of application servers associated with the client and a communication component for receiving at least one notification request to maintain the notification channel. The communication component can be further configured to send replies associated with providing the event notifications, from the plurality of application servers, to the client. The request includes information associated with managing the notification channel. In this exemplary embodiment, maintaining the notification channel can be performed by, for example, using web sockets.

According to one exemplary embodiment, a method for obtaining event notifications by a client comprises: establishing a notification channel with a notification gateway, requesting at least one subscription to a service enabler including an identifier of a resource associated with said notification channel, and transmitting a long polling request message to a notification gateway. These steps can be performed by the client transmitting HTTP messages.

According to another embodiment, a method for providing event notifications to a client comprises: receiving a notification channel establishment request from said client, transmitting notification channel information toward said client, receiving a long polling request from said client and transmitting, when received, a notification request toward said client. These steps can be performed by a notification gateway transmitting and receiving HTTP messages.

According to another embodiment, a client device includes a processor configured to execute a browser application and further configured to transmit and receive HTTP messages to perform the functions of establishing a notification channel with a notification gateway, requesting at least one subscription to a service enabler including an identifier of a resource associated with said notification channel, and transmitting a long polling request message to a notification gateway.

According to another embodiment, a notification gateway server includes a processor configured to provide event notifications to a client by receiving a notification channel establishment request from said client, transmitting notification channel information toward said client, receiving a long polling request from said client and transmitting, when received, a notification request toward said client.

### BRIEF DESCRIPTION OF THE DRAWINGS

The accompanying drawings illustrate exemplary embodiments, wherein:

FIG. 1 depicts an exemplary resource tree identifying HTTP resources associated with a notification channel;

FIG. 2 depicts an exemplary signaling sequence associated with a notification channel creation and long polling;

FIG. 3 depicts an exemplary signaling sequence associated with an alternative and more detailed chat session notification channel creation and long polling;

FIG. 4 depicts an exemplary signaling sequence associated with a notification channel creation and long polling, including enabler subscription by a notification gateway;

FIG. 5 depicts an exemplary computing environment for the operation of a client device;

FIG. 6 depicts an exemplary embodiment of a notification gateway server;

FIG. 7 depicts an exemplary embodiment of a client device;

FIG. 8 depicts an exemplary method for obtaining event notifications by a client;

FIG. 9 depicts an exemplary method for providing event notifications to a client; and

FIG. 10 depicts an exemplary computing environment for implementing methods for providing event notifications to a client or obtaining event notifications by a client.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

As mentioned above, the implementation of various OMA APIs using a subscribe/notify mechanism may be problematic for thin clients. RCS wants to address thin clients typically running in web browsers and, since there is no web server in the browser, the subscribe/notify mechanism will not work (as an HTTP request from the server->client is not possible). Instead RCS has requested OMA to support a new type of notification mechanism on top of the currently specified “subscribe/notify” mechanism called “long polling.”

One solution could be to add the support for long polling in a respective API, but that would mean that the client implementation (in the web browser) would have to establish a long polling request towards each enabler in the RCS service suite. This could imply that there would be approximately 10-15 parallel connections established and some browsers have a limitation on the number of parallel requests that a client may establish. Thus, RCS has requested OMA to develop a solution allowing a thin client to only have one long polling request covering events from all services.

According to one embodiment, this problem is addressed by providing a new function, referred to herein as a Notification Gateway (NGW), which is capable of collecting events from all enablers and delivering them to the client in response to a long polling request. According to an embodiment, the NGW is generic and hence not aware of any particular service; instead the NGW conveys the event(s) received in the notification from the enabler and appends those event(s) to the 200 OK response to the client.

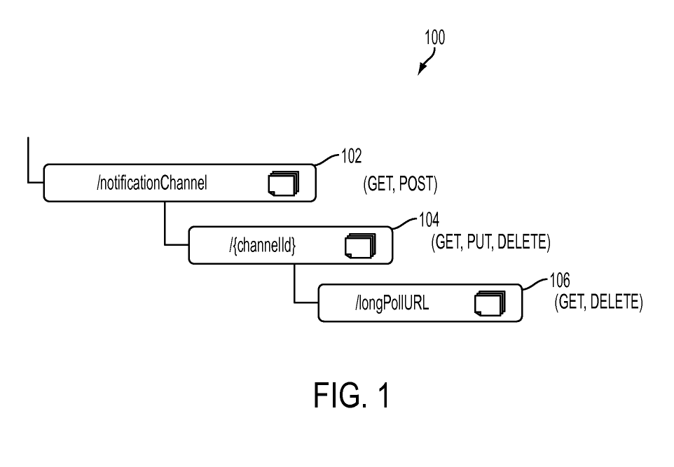

According to an embodiment, the client will, upon start-up, create a notification channel, which basically creates a new resource in the NGW where events from the enabler are kept until they are passed on to the client (e.g., in the 200 OK response). The notification channel can, for example use the resources identified in the resource tree 100 shown in FIG. 1, and can use the HTTP methods shown next to each resource. More specifically, according to an embodiment, the resources involved can include channel establishment 102 (e.g., using HTTP Get and/or HTTP Post), usage of the established notification channel 104 to subscribe to events (e.g., using HTTP Get, Put and/or Delete) and then initiation of the long polling mechanism 106 to receive notifications (e.g., using HTTP Get and/or Delete). The resource tree 100 can, for example, be part of a separate API for the notification channel or it can be included in each RC API that support notifications to clients.

According to an embodiment, and to provide some more detail on the three exemplary phases described above, in response to a request from a client or user agent to create a notification channel the following data can be included:
CHANNEL ID—The Channel Id is provided in the Location header allowing the client to manage the notification channel later on, such as for refresh and when removing it (when logging out).
LONG POLLING URL—The URL that the client will use to receive new events.
CALLBACK URL—A URL pointing to a resource created when the notification channel was created. This allows each enabler to send notifications allowing the NGW to buffer events until they are delivered/retrieved by the client.
   In the next step, the client establishes subscriptions for each enabler that it wants to receive events from by sending the HTTP subscribe request including the Callback URL (which points to the NGW). The Callback URL is then used when sending notifications. The client will then send the first long polling request using the Long polling URL in order to receive a new event. As soon as a new event has occurred by receiving a 200 OK a new long polling request is sent in order to always have an active request available in the NGW. It should be noted in the exemplary embodiment that the long polling mechanism can be replaced by other common notification mechanisms such as, but not limited to web sockets, etc.

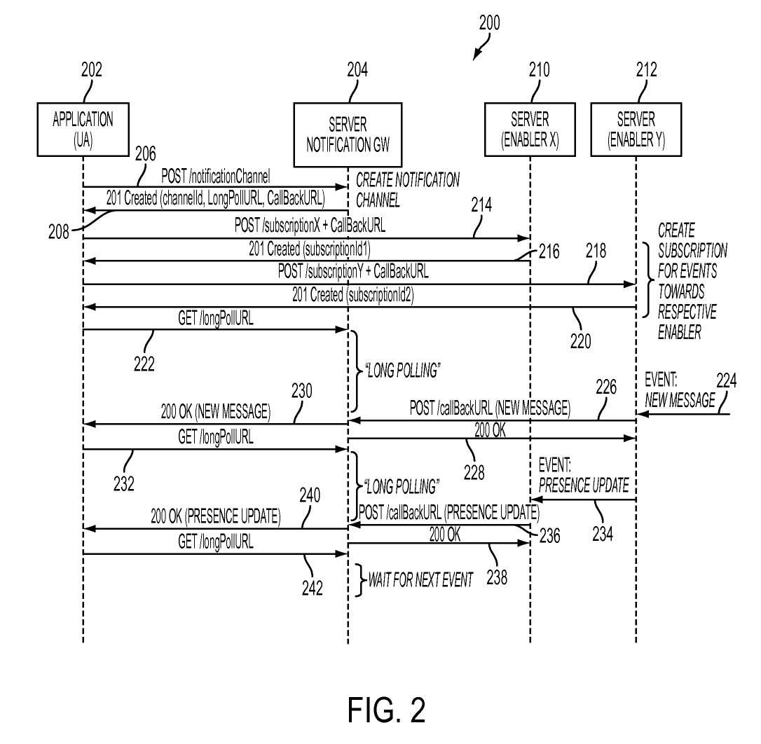

FIG. 2 provides an example of signaling sequences associated with notification channel creation and long polling according to an embodiment. Therein, the notification channel is established between an application (UA or client) 202 and a NGW server 204 via signals 206 and 208. Then, the UA/client 202 can create subscriptions for events toward respective servers 210 and 212 via signals 214-220. It will be appreciated that more or fewer than two enabler servers could be contacted during this phase.

The UA/client 202 can then send an HTTP GET/longPollURL signal to the notification gateway server 204, which will trigger a response when a subscribed event occurs. For example, when a new event associated with the subscription established with enabler Y 212 (e.g., a location-based event which occurs when the device operating UA/client 202 moves to a location that triggers a subscription) occurs, the corresponding enabler Y 212 receives an event message 224 and sends that to the notification gateway server via signal 226, which is acknowledged via signal 228. The message is then provided to the UA/client 202 via signal 230.

The UA/client 202 then resets the notification channel, to await further notifications, by transmitting another long polling signal 232 to notification gateway server 204. When another event occurs, e.g., as represented by signal 234 associated with a presence event update, signals 236-240 repeat the afore-described process to alert the UA/client 202. Then the notification mechanism is again set up to await the next event by signal 242.

From the foregoing it will be appreciated that embodiments described herein provide a long polling method which a client with a browser application can use to receive notifications from the server about the events the client is subscribed for. The notifications are conveyed through a common notification channel and therefore before the “long polling” can be invoked the client shall first create notification channel. The channel is created using a POST request to the “notification gateway” server and, after successful resource creation on the server, the client receives a resource URL (LongPollURL) that shall be used to initiate “long polling” as well as the resource URL (CallBackURL) where an “enabler” server is supposed to send notifications for which the client is subscribed.

It is possible for a client to create multiple notification channels; generally one channel per client application instance. Following the channel creation, the client can use the received “CallBackURL” and subscribe for notifications to enabler(s) for the events the client would like to be informed. Note that subscriptions can be specific for each enabler. Finally, the client initiates “long polling” with a GET request towards the “notification gateway” using “LongPollURL”. This “long polling” needs to be refreshed at regular intervals (defined by server policy) with a new GET request as long as the client is interested in receiving such notifications. When the “notification gateway” server receives a notification from an “enabler” server, it conveys the notification to the client with the response to the pending GET request. The Notification channel can be used in conjunction with both session based and non-session based APIs.

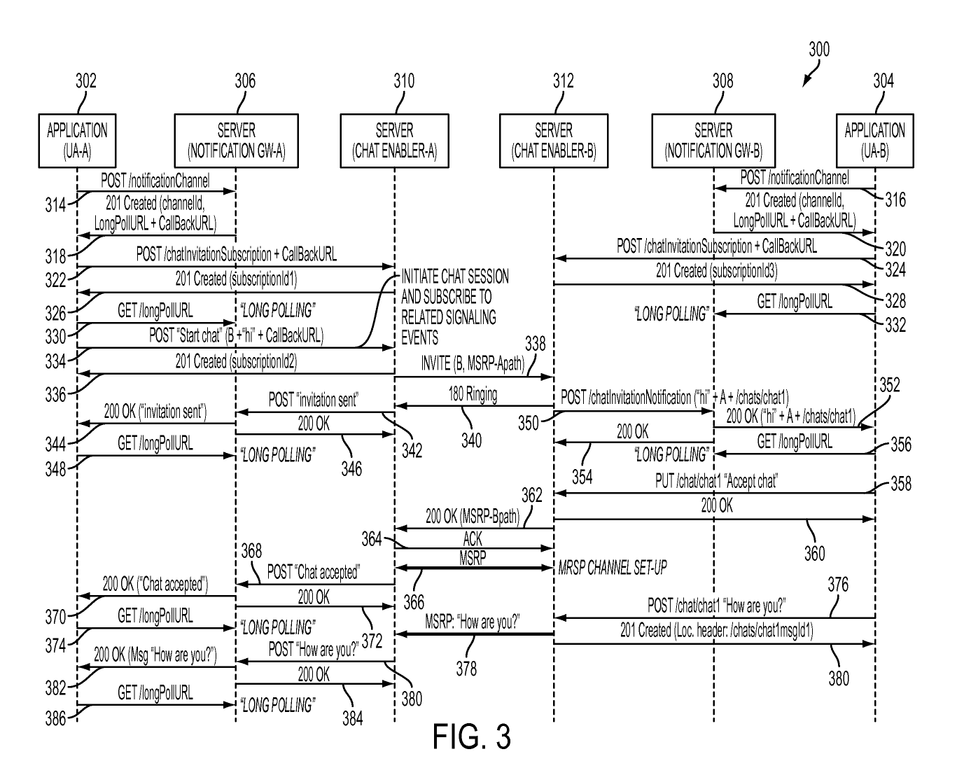

Looking now to FIG. 3, an example of signaling sequences associated with notification channel creation and long polling according to an exemplary embodiment for a chat session 300 is depicted. It should be noted in the exemplary embodiment that a chat session 300 involves two or more user applications 302, 304 communicating with each other so the exemplary embodiment depicts a mirrored arrangement of user applications 302, 304, notification gateways 306, 308 and chat enabler servers A 310 and B 312. It should further be noted in the exemplary embodiment that the exemplary embodiment can also be configured with a single notification gateway.

First in the exemplary embodiment, user application A 302 sends a Notification Channel creation message 314 toward notification gateway A 306 and user application B 304 sends a Notification Channel creation message 316 toward notification gateway B 308. It should be noted in the exemplary embodiment that the messages can be sent at different times. Next in the exemplary embodiment, notification gateway A 306 sends a reply 318 toward user application A 302 with information associated with the created notification channel A and notification gateway B 308 sends a reply 320 toward user application B 304 with information associated with the created notification channel B. It should be noted in the exemplary embodiment that the information returned to user application A 302 and user application B 304 is unique and can comprise but is not limited to a channel identity, a long polling URL and a callback URL with the long polling URL for the user application 302, 304 to access the notification gateway 306, 308 and the callback URL for the user application 302, 304 to provide to a chat enabler server A 310 and a chat enabler server B 312, respectively.

Next in the exemplary embodiment, the user application A 302 sends a Chat Invitation Subscription message 322 toward the chat enabler A 310 and the user application B 304 sends a Chat Invitation Subscription message 324 toward the chat enabler B 312. It should be noted in the exemplary embodiment that the callback URL received previously is sent as part of the subscription message to the chat enabler server A 310 and B 312. Continuing with the exemplary embodiment, the chat enabler server A 310 sends a Created reply 326 toward the user application 302 and the chat enabler server B 312 sends a Created reply 328 toward the user application 304. It should be noted in the exemplary embodiment that the Created replies 326, 328 include a subscription identity for subsequent use by the user application 302, 304. Next in the exemplary embodiment, the user application A 302 sends a Long Poll request toward the notification gateway A 306 and the user application B 304 sends a long poll request toward the notification gateway B 308. It should be noted in the exemplary embodiment that both user application A 302 and user application B 304 have an outstanding long poll request and are awaiting the arrival of an event notification from the notification gateway A 306 and notification gateway B 308, respectively.

Continuing with the exemplary embodiment, user application A 302 sends a start chat message 334 toward chat enabler server A 310 to initiate a chat session with user application B 304. It should be noted in the exemplary embodiment that the start chat message comprises but is not limited to the destination of the chat session, the text of the first chat and a callback URL of notification gateway A 306. Next in the exemplary embodiment, the chat enabler server A 310 sends a Created reply 336 to the start chat 334 message toward the user application A 302. It should be noted in the exemplary embodiment that the Created reply 336 comprises but is not limited to a subscription identity for the chat session.

Next in the exemplary embodiment, the chat enabler server A 310 sends an invite message 338 toward the chat enabler server B 312. It should be noted in the exemplary embodiment that the Invite message 338 comprises but is not limited to the destination of the chat session and an MSRP path for establishing MSRP communications. Continuing with the exemplary embodiment, chat enabler server B 312 sends a ringing message 340 toward chat enabler server A 310. Continuing with the exemplary embodiment, in reaction to receiving the ringing message 340, the chat enabler server A 310 sends and invitation sent notification 342 toward the notification gateway server A 306 and the notification gateway server A 306 replies to the outstanding long poll 330 with an OK event 344 toward the user application A 302 comprising information associated with the invitation sent event and an OK reply message 346 toward the chat enabler server A 310. Next in the exemplary embodiment, the user application A 302 sends a long poll 348 toward the notification gateway server A 306 to maintain an outstanding long poll request for the next event from the notification gateway server A 306.

Next in the exemplary embodiment and concurrent to the chat enabler server A processing the invitation sent event 342, the chat enabler server B 312 sends a chat invitation notification event 350 toward the notification gateway server B 308 and the notification gateway server B 308 replies to the outstanding long poll 332 with an ok event 352 toward the user application B 304 comprising information associated with the chat invitation notification and sends an ok reply 354 toward the chat enabler server B. It should be noted in the exemplary embodiment that the information associated with the chat invitation notification comprises but is not limited to a text message, the identity of the sender of the text message and a chat identity. Next in the exemplary embodiment, the user application B 304 sends a long poll 356 toward the notification gateway server B 308 to maintain an outstanding long poll request for the next event from the notification gateway server B 308.

Continuing with the exemplary embodiment, the user application B 304 accepts the invitation to the chat session 352 by sending an accept chat message 358 toward the chat enabler server B 312 to which the chat enabler server B 312 sends an ok reply 360 toward the user application B 304. Next in the exemplary embodiment, the chat enabler server B 308 sends an ok reply 362 to the invite message 338 toward the chat enabler server A 310. It should be noted in the exemplary embodiment that information associated with the ok reply 362 comprises but is not limited to an MSRP path associated with the chat session. Next in the exemplary embodiment, the chat enabler server A 310 sends an acknowledgement 364 to the ok reply 362 to the chat enabler server B 312 and the chat enabler server A 310 and chat enabler server B 312 continue to establish the MSRP communication channel 366. It should be noted in the exemplary embodiment that all of the steps associated with establishing the MSRP communication channel 366 are not shown.

Next in the exemplary embodiment, the chat enabler server A 310, in response to receiving the ok reply 362 from the chat enabler server B 312, sends a chat accepted message 368 toward the notification gateway server A 306. Next in the exemplary embodiment and in response to receiving the chat accepted message 368, the notification gateway server A 306 sends an ok reply 370 to the outstanding long poll 348 toward the user application A 302 and an ok reply to the chat enabler server A 310. It should be noted in the exemplary embodiment that the ok reply 370 comprises but is not limited to information informing the user application A 302 that the chat request is accepted. Next in the exemplary embodiment, the user application A 302 sends a long poll message 374 toward the notification gateway server A 306 to maintain an outstanding long poll request for the next event from the notification gateway server A 306. It should be noted in the exemplary embodiment that the chat session is now established between user application A 302 and user application B 304.

Continuing with the exemplary embodiment, the user application B 304 replies to the initial chat text message 352 by sending a chat text message 376 toward user application A 302 via chat enabler server B 312. Next in the exemplary embodiment, chat enabler server B 312 forwards the chat text message 378 toward chat enabler server 310. It should be noted in the exemplary embodiment that the chat text message 378 is sent over the MSRP channel. Continuing with the exemplary embodiment, the chat enabler server A 310 sends the chat text message 380 to the notification gateway server A 306. Next in the exemplary embodiment, the notification gateway server A 306 replies to the outstanding long poll request 374 by sending an ok message 382 toward user application A 302 and by sending an ok reply 384 to the chat enabler server A 310. Next in the exemplary embodiment, the user application A 302 sends a long poll 386 toward the notification gateway server A 306 to maintain an outstanding long poll request for the next event from the notification gateway server A 306.

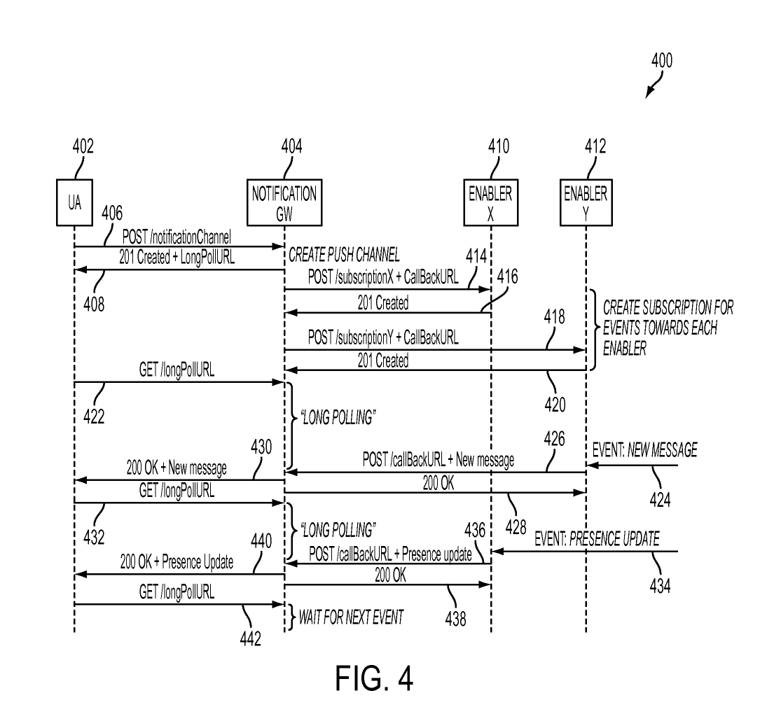

FIG. 4 illustrates an alternative embodiment, wherein the NGW is aware of the enablers and will, on-behalf of the client, establish subscriptions for each service. The client has to provide the subscription related information in the POST request when creating the notification channel, e.g., the name of the services/events to subscribe for as well as more detailed information like contact list name when subscribing for presence information etc.

First in the exemplary embodiment, the notification channel is established between an application (UA or client) 402 and a notification gateway server 404 via signals 406 and 408. Next in the exemplary embodiment, the notification gateway server 404 can create subscriptions for events toward enabler server X 410 and enabler server Y 412 via signals 414 and 416 associated with enabler server X and signals 418 and 420 associated with enabler server Y 412. It will be appreciated that more or fewer than two enabler servers can be associated with subscriptions created by user application (UA or client) 402.

The application (UA or client) 402 can then send an HTTP GET/longPoll URL signal 422 toward the notification gateway server 404, which will trigger a response when a subscribed event occurs. For example, when a new event associated with the subscription established with enabler Y 412 (e.g., a location-based event which occurs when the device operating application UA or client 402 moves to a location that triggers a subscription) occurs, the corresponding enabler Y 412 receives an event message 424 and sends that to the notification gateway server via signal 426, which is acknowledged via signal 428. The message is then provided to the application (UA or client) 402 via signal 430.

The application (UA or client) 402 then resets the notification channel, to await further notifications, by transmitting another long polling signal 432 to notification gateway server 404. When another event occurs, e.g., as represented by signal 434 associated with a presence event update, signals 436-440 repeat the afore-described process to alert the application (UA or client) 402. Then the notification mechanism is again set up to await the next event by signal 442.

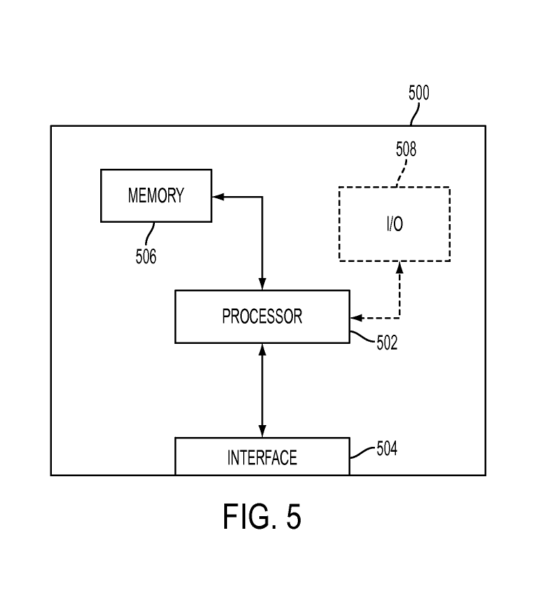

An exemplary device which runs UA/client 202, or which operates as a notification gateway server 204, is generically illustrated in FIG. 5. Therein, the device or server 500 includes a processor 502 which is configured to receive and transmit signals, e.g., HTTP signals or messages, via interface 504, e.g., as described above with respect to the signaling diagrams of FIGS. 2-4. The processor 502 may also be connected to one or more memory device(s) 506. When operating as a terminal or client device, the device 500 will likely also include one or more input/output devices represented by block 508, e.g., a display screen, in which to provide a user with an output which is representative of a received notification.

Embodiments descried herein can provide various advantages and benefits. For example, for embodiments wherein the notification gateway server is implemented in a generic manner, such embodiments provide a generic service allowing events from any type of enabler that exposes a subscribe/notify interface over HTTP to be delivered to a client over just one single long polling channel. Alternatively, when implemented as a service-aware node, the client does not have to take care of the management of the subscriptions, such as refresh and termination, which is instead handled by the notification gateway. Exemplary embodiments are particularly useful for, but not limited to, devices that don't support OMA Push, e.g., a browser operating on a personal computer. Moreover although the foregoing exemplary embodiments refer to RCS APIs, embodiments can be used in conjunction with other OMA REST APIs.

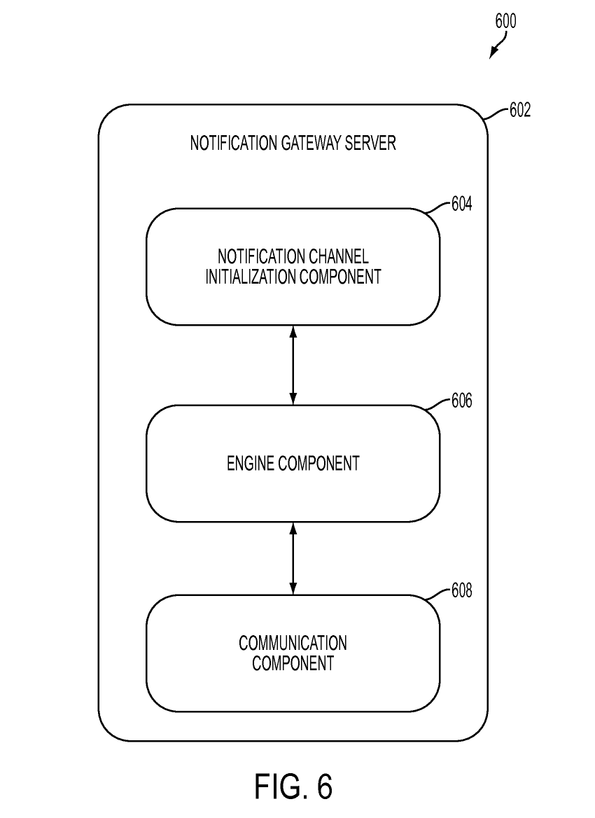

Looking now to FIG. 6, an exemplary embodiment 600 of a notification gateway server 602 is depicted. The exemplary embodiment 600 notification gateway server 602 comprises a notification channel initialization component 604, an engine component 606 and a communication component 608. In one aspect of the exemplary embodiment, the notification gateway server 602 resides on a communication network with the address of the notification gateway server 602 known to all other nodes on the communication network desiring to use the services of the notification gateway server 602. It should be noted in the exemplary embodiment that the address of the of the notification gateway server 602 can be a preconfigured parameter for a user of the services provided by the notification gateway server 602 or it can be obtained by other mechanisms associated with determining the address of a network server based on information related to the operation and/or function of the network server. It should further be noted in the exemplary embodiment that the notification channel initialization component further comprises a subscription initialization component (not shown) for establishing subscriptions with one or more enablers based on information provided by the client.

Continuing with the exemplary embodiment, a notification channel initialization component 604 provides for processing a command to establish a notification channel between the notification gateway server 602 and a client desiring to use the services provided by the notification gateway server 602. In another aspect of the exemplary embodiment, the notification channel initialization component 604 manages requesting system resources associated with a notification channel and the subsequent return of the resources when the notification channel is no longer required.

Next in the exemplary embodiment, an engine component 606 processes communications, either requests or replies, associated with the operation of a notification channel. In one aspect of the exemplary embodiment, the engine component 606, on behalf of a client can establish subscriptions for each enabler from which the client desires to receive notification events. It should be noted in the exemplary embodiment that the client can send requests to establish subscriptions directly to the enablers while providing the enablers the address of the notification gateway server 602 for the processing of event notifications. It should further be noted in the exemplary embodiment, that the engine component 606 further comprises a mapping component (not shown) for storing the delivery address of any event notifications received by the engine component 606.

In another aspect of the exemplary embodiment, a client will send a notification request to the notification gateway server 602 and the engine component 606 will receive the notification request and await an event notification from a subscribed enabler. Next in the exemplary embodiment, when an event notification is received at the notification gateway server 602 and forwarded to the engine component 606, the engine component 606 processes the information received in the event notification and sends a reply to the notification request, including the associated information, to the client associated with the outstanding notification request. It should be noted in the exemplary embodiment that a client can have a plurality of subscriptions and the notification gateway server can act as a multiplexor for a client, providing all notifications received for the client from the plurality of enablers on the notification channel established by the client.

Further in the exemplary embodiment, a communication component 608 of the notification gateway server 602 provides the ability to send and receive communications associated with a client establishing and using event notifications from one or more enablers operating on the network. In the exemplary embodiment, the communication component receives communications, either requests/commands or replies and delivers them to the engine component 606 for further processing. It should be noted in the exemplary embodiment that under certain circumstances, the communications can simply be redirected to their destination address based on the type of communication received. It should further be noted in the exemplary embodiment that the communication component further comprises an HTTP component (not shown) for formatting communications associated with the communication component.

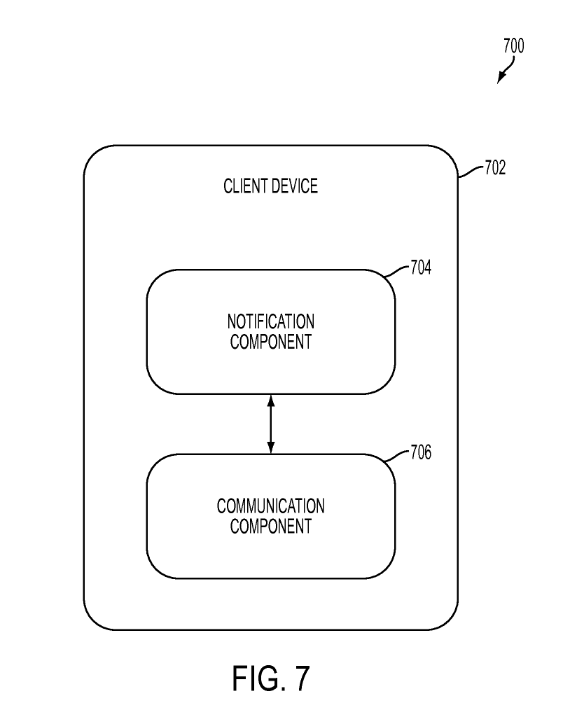

Looking now to FIG. 7, a client device 702 of the exemplary embodiment 700 is depicted. The client device 702 comprises a notification component 704 and a communication component 706. In one aspect of the exemplary embodiment, the notification component 704 provides the capability to generate a request to establish a notification channel. It should be noted in the exemplary embodiment that the notification channel establishment request is sent to the notification gateway server for processing.

Continuing with the exemplary embodiment, the notification component 704 provides the capability to generate a notification request for processing by the notification gateway server. It should be noted in the exemplary embodiment that the notification request remains outstanding with the notification gateway server until an event notification, for the associated notification channel is received by the notification gateway server, after the notification gateway server receives an event notification on the associated notification channel, a reply is prepared by the notification gateway server and returned to the notification component 704 of the client device 702. It should be noted in the exemplary embodiment that this mechanism provides an asynchronous behavior for the client device 702 with respect to the outstanding notification request.

Further in the exemplary embodiment, a communication component 706 of the client device 702 provides the ability to send and receive communications associated with establishing and using event notifications from one or more enablers operating on the network. In the exemplary embodiment, the communication component receives communications and delivers them to the notification component 706 for further processing. It should be noted in the exemplary embodiment that under certain circumstances, the reply to a notification request can be displaced by the amount of time between send the notification request and the arrival an event notification from any of the subscribed enablers.

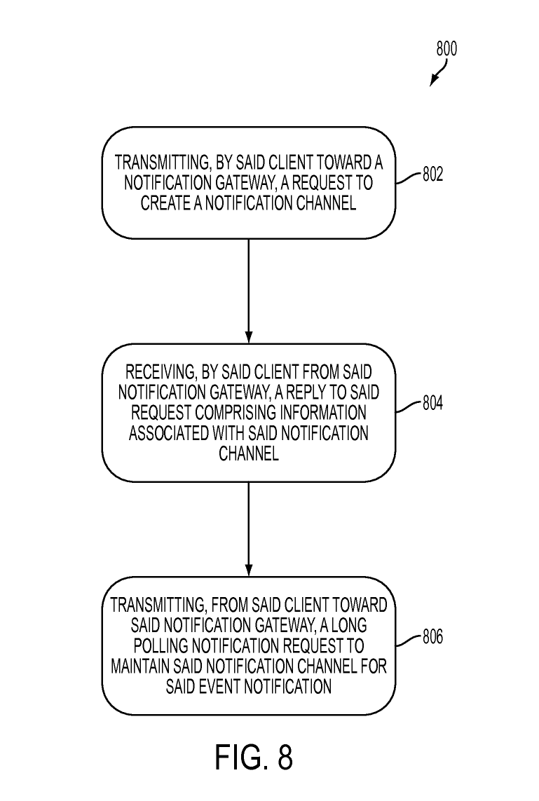

Looking now to FIG. 8, an exemplary method embodiment 800 for obtaining event notifications by a client is depicted. First at step 802 of the exemplary method embodiment 800, the client transmits a request to create a notification channel to a notification gateway server. It should be noted in the exemplary method embodiment 800 that the client request can contain information necessary for the notification gateway server to process the request such as but not limited to the address of the client and the identity of any enablers from which the client desires to receive event notifications.

Next, at step 804 of the exemplary method embodiment, the client receives a reply to the request to create a notification channel from the notification gateway server. In the exemplary method embodiment, the reply from the notification gateway server comprises information associated with the notification channel. It should be noted in the exemplary embodiment that the information can comprise an identity of the created notification channel, an address the client will use to receive notification events and an address to provide to each enabler of interest to the client allowing the enabler to provide notification events to the notification gateway server, as they occur, for delivery to the appropriate client.

Next, at step 806 of the exemplary embodiment, the client transmits a notification request to the notification gateway server. In the exemplary embodiment, the notification gateway server will send a reply to the client when a notification event is received from one of the enablers subscribed to by the client. It should be noted in the exemplary embodiment that the time between the notification request sent by the client and the reply to the notification request sent by the notification gateway server varies based on generation of notification events by the enablers.

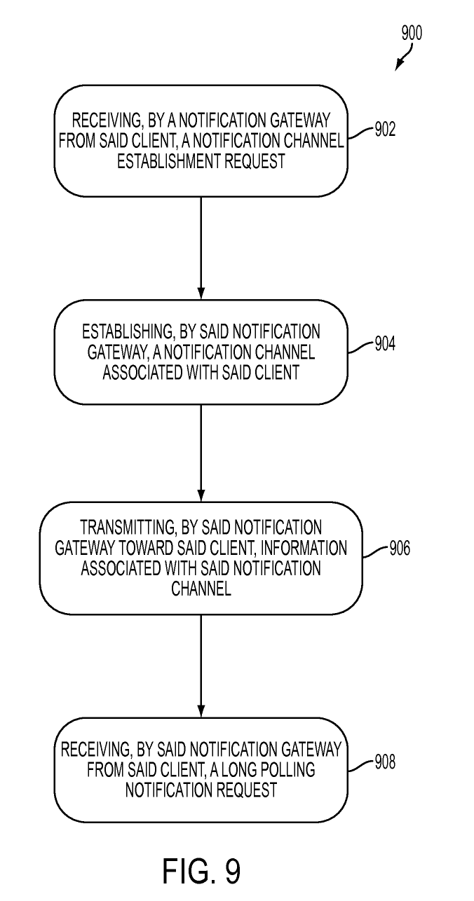

Looking now to FIG. 9, an exemplary method embodiment 900 for providing event notifications to a client is depicted. First, at step 902 of the exemplary embodiment, a notification gateway server receives a request from a client to establish a notification channel for the client. It should be noted that the client can also provide information associated with desired enablers, allowing the notification gateway server to establish subscriptions for services on behalf of the client.

Next, at step 904 of the exemplary method embodiment, the notification gateway server establishes a notification channel for communication of enabler event notifications to the client. Continuing with the exemplary embodiment, the notification gateway server allocates resources necessary to manage the notification channel and the associated notification events arriving from the subscribed enablers and sent to the client. It should be noted in the exemplary embodiment that the resources can include but are not limited to lists of enablers and their addresses, lists of received notification events, information associated with the client and information associated with subscribing to an enabler on the clients behalf.

Further, at step 906 of the exemplary embodiment, the notification gateway server sends a reply to the client's notification channel establishment request containing information associated with the established notification channel. It should be noted in the exemplary embodiment that the reply can include information such as but not limited to an identifier for the notification channel, a first address that the client will use to receive new events and a second address, associated with the notification gateway server, for use by the enablers to send event notifications for delivery to the client associated with the second address.

Next, at step 908 of the exemplary method embodiment, the notification gateway server receives a notification request from the client. In the exemplary method embodiment, the notification request can be, but is not limited to, a long polling request associated with the HTTP protocol. It should be noted in the exemplary method embodiment that the client maintains an outstanding notification request with the notification gateway server. For example, each time a notification event is received in a reply to the outstanding notification request, the client sends another notification request to the notification gateway server to prepare for the next notification event.

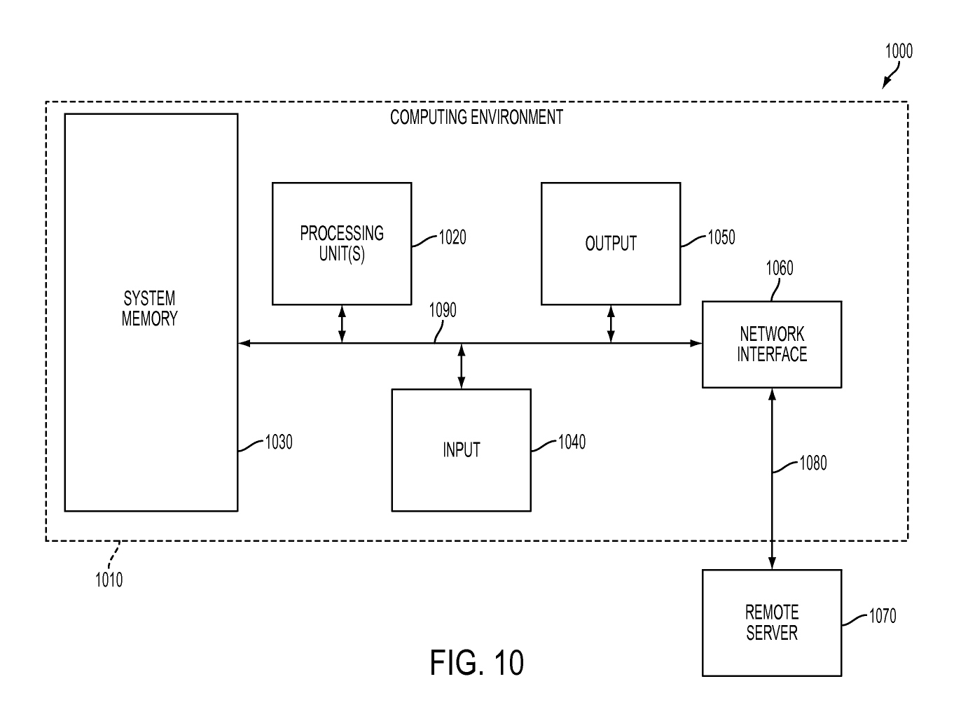

Looking now to FIG. 10, another example of a suitable computing system environment 1000 in which the claimed subject matter can be implemented, although as made clear above, the computing system environment 1000 is only one example of a suitable computing environment for an exemplary embodiment and is not intended to suggest any limitation as to the scope of use or functionality of the claimed subject matter. Further, the computing environment 1000 is not intended to suggest any dependency or requirement relating to the claimed subject matter and any one or combination of components illustrated in the example computing environment 1000.

Looking now to FIG. 10, an example of a device for implementing the previously described innovation includes a general purpose computing device in the form of a computer 1010. Components of computer 1010 can include, but are not limited to, a processing unit 1020, a system memory 1030, and a system bus 1090 that couples various system components including the system memory to the processing unit 1020. The system bus 1090 can be any of several types of bus structures including a memory bus or memory controller, a peripheral bus, and a local bus using any of a variety of bus architectures.

Computer 1010 can include a variety of computer readable media. Computer readable media can be any available media that can be accessed by computer 1010. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, random access memory (RAM), read only memory (ROM), electronically erasable/programmable read only memory (EEPROM), flash memory or other memory technology, compact disk read only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 1010. Communication media can embody computer readable instructions, data structures, program modules or other data in a modulated data signal such as a carrier wave or other transport mechanism and can include any suitable information delivery media.

The system memory 1030 can include computer storage media in the form of volatile and/or nonvolatile memory such as read only memory (ROM) and/or random access memory (RAM). A basic input/output system (BIOS), containing the basic routines that help to transfer information between elements within computer 1010, such as during start-up, can be stored in memory 1030. Memory 1030 can also contain data and/or program modules that are immediately accessible to and/or presently being operated on by processing unit 1020. By way of non-limiting example, memory 1030 can also include an operating system, application programs, other program modules, and program data.

The computer 1010 can also include other removable/non-removable and volatile/nonvolatile computer storage media. For example, computer 1010 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1090 through a non-removable memory interface such as an interface, and a magnetic disk drive or optical disk drive can be connected to the system bus 1090 by a removable memory interface, such as an interface.

A user can enter commands and information into the computer 1010 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 1020 through user input 1040 and associated interface(s) that are coupled to the system bus 1090, but can be connected by other interface and bus structures, such as a parallel port, game port or a universal serial bus (USB).

A graphics subsystem can also be connected to the system bus 1090. In addition, a monitor or other type of display device can be connected to the system bus 1090 through an interface, such as output interface 1050, which can in turn communicate with video memory. In addition to a monitor, computers can also include other peripheral output devices, such as speakers and/or printing devices, which can also be connected through output interface 1050.

The processing unit 1020 can comprise a plurality of processing cores providing greater computational power and parallel computing capabilities. Further, the computing environment 1000 can contain a plurality of processing units providing greater computational power and parallel computing capabilities. It should be noted that the computing environment 1000 can also be a combination of multi-processor and multi-core processor capabilities.

The computer 1010 can operate in a networked or distributed environment using logical connections to one or more other remote computers, such as remote server 1070, which can in turn have media capabilities different from device 1010. The remote server 1070 can be a personal computer, a server, a router, a network PC, a peer device or other common network node, and/or any other remote media consumption or transmission device, and can include any or all of the elements described above relative to the computer 1010. The logical connections depicted in FIG. 10 include a network 1080, such as a local area network (LAN) or a wide area network (WAN), but can also include other networks/buses.

When used in a LAN networking environment, the computer 1010 is connected to the LAN 1080 through a network interface 1060 or adapter. When used in a WAN networking environment, the computer 1010 can include a communications component, such as a modem, or other means for establishing communications over a WAN, such as the Internet. A communications component, such as a modem, which can be internal or external, can be connected to the system bus 1090 through the user input interface at input 1040 and/or other appropriate mechanism.

In a networked environment, program modules depicted relative to the computer 1010, or portions thereof, can be stored in a remote memory storage device. It should be noted that the network connections shown and described are exemplary and other means of establishing a communications link between the computers can be used.

Additionally, it should be noted that as used in this application, terms such as “component,” “display,” “interface,” and other similar terms are intended to refer to a computing device, either hardware, a combination of hardware and software, software, or software in execution as applied to a computing device implementing a virtual keyboard. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

Further, the term to “infer” or “inference” refer generally to the process of reasoning about or inferring states of the system, environment, user, and/or intent from a set of observations captured from events and/or data. Captured events and data can include user data, device data, environment data, behavior data, application data, implicit and explicit data, etc. Inference can be employed to identify a specific context or action, or can generate a probability distribution over states, for example. The inference can be probabilistic in that the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The above-described exemplary embodiments are intended to be illustrative in all respects, rather than restrictive, of the present innovation. Thus the present innovation is capable of many variations in detailed implementation that can be derived from the description contained herein by a person skilled in the art. All such variations and modifications are considered to be within the scope and spirit of the present innovation as defined by the following claims. No element, act, or instruction used in the description of the present application should be construed as critical or essential to the invention unless explicitly described as such. Also, as used herein, the article “a” is intended to include one or more items.

1. A method, stored in a memory and executing on a processor, for obtaining event notifications by a client, said method comprising:
transmitting, by said client toward a notification gateway, a request to create a notification channel;
receiving, by said client from said notification gateway, a reply to said request comprising information associated with said notification channel; and
transmitting, from said client toward said notification gateway, a long polling notification request to maintain said notification channel for said event notification.

2. The method of claim 1, wherein said request to create a notification channel includes information associated with establishing subscriptions with enablers.

3. The method of claim 1, wherein said request to create a notification channel is a hypertext transfer protocol (HTTP) protocol message.

4. The method of claim 3, wherein said HTTP protocol message is a POST or PUT message.

5. The method of claim 1, wherein said long polling notification request is a hypertext transfer protocol (HTTP) protocol message.

6. The method of claim 5, wherein said HTTP protocol message is a POST or GET message.

7. The method of claim 1, wherein the information associated with the notification channel is a long polling uniform resource locator (URL).

8. A method, stored in a memory and executing on a processor, for providing event notifications to a client, said method comprising:
receiving, by a notification gateway from said client, a notification channel establishment request;
establishing, by said notification gateway, a notification channel associated with said client;
transmitting, from said notification gateway toward said client, information associated with said notification channel; and
receiving, by said notification gateway from said client, a long polling notification request.

9. The method of claim 8, wherein said notification channel establishment request further comprises establishing one or more subscriptions with enablers on behalf of said client.

10. The method of claim 9, wherein establishing said one or more subscriptions further comprises providing a hypertext transfer protocol (HTTP) callback uniform resource locator (URL) for sending notification events from said enablers toward said notification gateway.

11. The method of claim 9, wherein said notification gateway sends a reply to said client's outstanding said long polling notification request and to said one or more enabler's said notification event.

12. The method of claim 8, wherein said information associated with said notification channel further comprises an identity associated with said notification channel, a hypertext transfer protocol (HTTP) uniform resource locator (URL) for use by said client to provide to enablers for use as a callback URL for sending event notifications associated with said client subscriptions.

13. The method of claim 12, wherein the identity associated with the notification channel is a long polling URL.

14. The method of claim 8, wherein said notification gateway receives a next long polling notification request, from said client, each time said gateway replies to said long polling notification request.

15. A notification gateway server for providing event notifications to one or more clients, said server comprising:
a processor for executing computer instructions and a memory for storing said computer instructions wherein said computer instructions further comprise:
a notification channel initialization component for establishing a notification channel with said client;
an engine component for processing information associated with said event notifications; and
a communication component for receiving at least one long polling request to maintain said notification channel and sending replies associated with providing said event notifications to said client.

16. The notification gateway server of claim 15, wherein said notification channel initialization component further comprises a subscription initialization component for establishing subscriptions with one or more enablers based on information provided by said client.

17. The notification gateway server of claim 15, wherein said engine component further comprises a mapping component for storing the destination addresses of the event notifications received by said engine component.

18. The notification gateway server of claim 15, wherein said communication component further comprises a hypertext transfer protocol (HTTP) component for formatting communications associated with said communication component.

19. The notification gateway server of claim 18, wherein said long polling request is an HTTP POST or GET request.

20. The notification gateway server of claim 18, wherein said event notifications are sent toward said client as a 200 OK reply to said POST or Get request.

21. The notification gateway server of claim 15, wherein the notification channel initialization component is further configured to transmit a long polling uniform resource locator (URL) toward the client in response to receipt of a signal which requests establishment of the notification channel.

22. A client device for obtaining event notifications, said device comprising:
a processor for executing computer instructions and a memory for storing said computer instructions wherein said computer instructions further comprise:
a notification component for generating one or more notification channel creation requests and one or more long polling notification requests; and
a communication component for sending and receiving information associated with obtaining said event notifications wherein said communication component maintains an outstanding long polling notification request.

23. The client device of claim 22, wherein said communication component further comprises a hypertext transfer protocol (HTTP) component for formatting communications associated with said communication component.

24. The client device of claim 23, wherein said notification channel creation request is an HTTP POST or PUT message.

25. The client device of claim 22, wherein said outstanding long polling notification request is maintained for all subscribed services associated with said client.

26. The client device of claim 22, wherein an outstanding long polling notification request is maintained for one or more subscribed services associated with said client.

27. The client device of claim 23, wherein said event notification is an HTTP 200 OK reply to an HTTP POST or GET request sent by said client.

28. The client device of claim 23, wherein the information associated with obtaining said event notifications received by the communication component includes a long polling uniform resource location (URL).

29. A notification gateway server apparatus for providing event notifications, said apparatus comprising:
a processor for executing computer instructions and a memory for storing said computer instructions wherein said computer instructions further comprise:
an initialization component for establishing a notification channel with a client;
a multiplexer component for consolidating event notifications from a plurality of application servers associated with said client; and
a communication component for receiving at least one notification request to maintain said notification channel and sending replies associated with providing said event notifications, from said plurality of application servers, to said client and wherein said request comprises information associated with managing said notification channel.

30. The notification gateway of claim 29, wherein the notification gateway server uses web sockets to maintain the notification channel.
